(19) United States
(12) Patent Application Publication
(10) Pub. No.: US 2020/0158061 A1
(43) Pub. Date: May 21, 2020

(54) PLASTIC TANK WITH A CONNECTION DEVICE

(71) Applicant: MAGNA STEYR Fuel Systems GesmbH, Sinabelkirchen (AT)

(72) Inventor: Bernd KAHLER, Graz (AT)

(21) Appl. No.: 16/601,764

(22) Filed: Oct. 15, 2019

(30) Foreign Application Priority Data
Nov. 19, 2018 (EP) EP18207032.6

(51) Int. Cl. F02M 37/00; B60K 15/03

(52) U.S. Cl. CPC F02M 37/0017; B60K 2015/047; B60K 15/03

(57) ABSTRACT

A plastic tank having a connection device for the plastic tank. The connection device includes a connection nipple, composed of a low-emission material, which is to be inserted into or attached to, from the outside, an opening of a tank wall of the plastic tank. A counter-piece is arranged to lay flat against the inside of the tank wall around the opening. The connection nipple is connected by screw connection or clip connection to the counter-piece. A seal is arranged around the opening between the outside of the tank wall and a sealing face of the connection nipple that faces the outside of the tank wall.

### CROSS-REFERENCE TO RELATED APPLICATIONS

The present application claims priority 35 U.S.C. § 119 to European Patent Publication No. EP 18207032.6 (filed on Nov. 19, 2018), which is hereby incorporated by reference in its complete entirety.

### TECHNICAL FIELD

Embodiments relate to a plastic tank having a connection device for the plastic tank, wherein the connection device comprises a connection nipple.

### BACKGROUND

Plastic tanks are increasingly used in the automotive industry, in particular as fuel tanks, and, in recent times, have been designed such that as few emissions as possible, in particular hydrocarbon emissions (HC emissions), can escape from the plastic tank.

To this end, plastic tanks are formed, for example, from high density polyethylene (HDPE) and, to achieve the target emissions, amongst other things, can use tank walls comprising a plurality of layers (multilayer tanks), which contain, for example, a barrier layer against hydrocarbon emissions.

It is known that, to connect lines such as vent lines, for example, connection devices such as nipples or nozzles are used, which are produced as separate components and are then connected, for example welded, to the plastic tank.

Conventional connection devices, however, exhibit relatively high hydrocarbon emissions.

### SUMMARY

Embodiments are to provide an enhanced plastic tanks having such connection devices in this regard and, in particular, provide a plastic tank having a connection device for the plastic tank which exhibits reduced hydrocarbon emissions. Embodiments are to also provide a method for producing such a plastic tank with reduced emissions.

In accordance with embodiments, a plastic tank includes a connection device for the plastic tank, wherein the connection device comprises a connection nipple which is inserted or attached from the outside into or to an opening of a tank wall of the plastic tank, and a counter-piece, which lies flat against the inside of the tank wall around the opening, wherein the connection nipple is screwed or clipped to the counter-piece, wherein a seal is arranged around the opening between the outside of the tank wall and a sealing face of the connection nipple, which sealing face faces the outside of the tank wall, wherein the connection nipple consists of a low-emission material.

In accordance with embodiments, a connection device is used, which uses a connection nipple made from a low-emission material, in particular, from polyoxymethylene (POM). The connection nipple is screwed or clipped from the outside to a counter-piece lying at least partially inside the plastic tank. A seal is arranged, in particular, clamped, between the counter-piece and the connection nipple, which seal is arranged around the opening on the outside of the tank wall on a sealing face of the connection nipple. As a result of this construction and, in particular, the use of a low-emission connection nipple and a seal arranged between the connection nipple and the counter-piece, the emissions at the connection point can be reduced by comparison with known connection points.

In accordance with embodiments, the plastic tank preferably consists of high density polyethylene (HDPE) and is preferably composed of multiple layers. The tank wall of the plastic tank preferably comprises a barrier layer against hydrocarbon emissions.

In accordance with embodiments, the counter-piece preferably consists of polyoxymethylene (POM) or high density polyethylene (HDPE) or is sheathed with HDPE.

In accordance with embodiments, the connection nipple is preferably designed for connecting a line, for example a vent line, or the connection nipple comprises a temperature sensor, in particular a PT sensor.

In accordance with embodiments, a supporting sleeve is arranged on the inside of the counter-piece for stabilising the counter-piece during the screwing or clipping to the connection nipple.

In accordance with embodiments, the counter-piece is preferably welded flat against the tank wall around the opening on the inside of the tank wall. In this case, both the tank wall, at least on its welded surface, and the counter-piece, at least on its welded surface, preferably consist of HDPE. The welding to the counter-piece can then preferably take place in the course of producing the plastic tank or in the course of moulding the tank walls.

In accordance with embodiments, the counter-piece can be hooked in at the inside of the tank wall. In this case, the counter-piece does not have to be welded to the tank wall and can be clipped into an opening in the tank wall from the outside, for example once the plastic tank has been produced.

In accordance with embodiments, a method is provided for producing an inventive plastic tank having a connection device for the plastic tank can provide that the plastic tank is thermoformed, the counter-piece is welded to the tank wall on the inside of the tank wall in the course of thermoforming the plastic tank and the connection nipple is fitted from outside the plastic tank after the thermoforming procedure, and screwed or clipped to the counter-piece.

An opening is preferably made in the tank wall at the position of the counter-piece, in particular, a circle cut of the tank wall at the position of the counter-piece, after the thermoforming procedure and before the connection nipple is fitted.

A seal is preferably applied to the tank wall at the position of the counter-piece before the connection nipple is fitted.

### DRAWINGS

Embodiments will be illustrated by way of example in the drawings and explained in the description below.

FIG. 1 illustrates a schematic sectional view of a detail of a plastic tank, which shows the connection device of the plastic tank, in accordance with an embodiment.

FIG. 2 illustrates a schematic sectional view of a detail of a plastic tank, which shows the connection device of the plastic tank, in accordance with another embodiment.

### DESCRIPTION

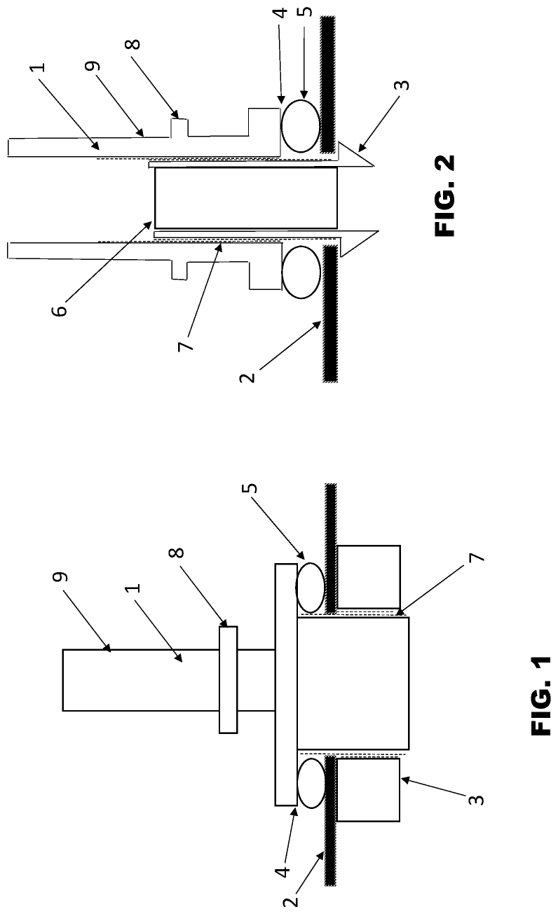

As illustrated in FIG. 1, a plastic tank is provided in accordance with embodiments. The plastic tank consists of high density polyethylene (HDPE), at least on its inner surface(s), preferably at least in both outer layers (multi-layer construction), or in its entirety, having a connection device for the plastic tank. The connection device comprises a connection nipple 1 made from polyoxymethylene (POM), a low-emission material. The connection nipple 1 is inserted from the outside into an opening of a tank wall 2 of the plastic tank. A counter-piece 3, which consists of high density polyethylene (HDPE), at least on an outer surface(s) thereof, is arrange so as to lay flat against the inner surface of the tank wall 2 around the opening. counter-piece 3 is connected via weld to the inner surface of the tank wall 2. The connection nipple 1 is connected via screw connection to the counter-piece 3 via a screw thread 7. To this end, the connection nipple 1 has external threading (shown by dashed lines) and the counter-piece 3 has corresponding internal threading (shown by dashed lines). A seal 5 is arranged between the outer surface of the tank wall 2 and a sealing face 4 of the connection nipple 1. The sealing face is to face the outer surface of the tank wall 2 and is aligned parallel to the tank wall 2. The seal 5 is arranged around the opening, in particular, clamped between the tank wall 2 and the sealing face 4. The seal 5 preferably consists of fluorocarbon rubber (FPM) and is to seal the interior of the plastic tank towards the outside environment.

The connection nipple 1 is designed for fluidically connecting a line, for example, a vent line, and therefore, has a rib 8 extending concentrically around a connection piece 9 to prevent an attached line from sliding down. The connection nipple 1 can alternatively be designed for supporting a PT sensor or other sensor, for example.

In the illustrated embodiment of FIG. 1, the counter-piece 3 is welded flat against the tank wall 2 around the opening on the inner surface of the tank wall 2, which is made from the same material as the counter-piece 3.

In the illustrated embodiment of FIG. 2, on the other hand, the counter piece 3 comprises a hook so as to hook in at the inner surface of the tank wall 2. In this illustrated embodiment, the counter-piece 3 is not welded to the tank wall 2, but instead, is only inserted into the opening from the outside, and hooked or clipped into the opening, once the plastic tank has been manufactured and a circle cut out for the opening in the tank wall 2. In this illustrated embodiment, the counter-piece 3 can consist of the same material, for example, as the connection nipple 1, in particular, of polyoxymethylene (POM).

The connection nipple 1 is again screwed to the counter-piece 3 via a screw thread 7. In the illustrated embodiment, the connection nipple 1 has internal threading (shown by dashed lines) and the counter-piece 3 has corresponding external threading (shown by dashed lines).

A supporting sleeve 6 is arranged on the inner surface of the counter-piece 3 for stabilizing the counter-piece 3 when connecting (via screwing or clipping) the connection nipple 1 to the counter-piece 3. Such a supporting sleeve 6 can also be used in the illustrated embodiment of FIG. 1.

A method for producing a plastic tank having a connection device for the plastic tank in the illustrated embodiment of FIG. 1, may include thermoforming a plastic material in order to produce the plastic tank while simultaneously welding the counter-piece 3 to the tank wall 2 on the inner surface of the tank wall 2. The welding of the counter-piece can be omitted for the illustrated embodiment of FIG. 2.

Next, after the thermoforming procedure, forming an opening in the tank wall 2 at the position of the counter-piece 3 or a desired position of the counter-piece 3. Forming the opening may be done by cutting out a circle or drilling.

A seal 5 is applied to the tank wall 2 around the opening at this position.

After the plastic tank has been thermoformed and the counter-piece 3 possibly inserted into the opening (for the illustrated embodiment of FIG. 2), the connection nipple 1 is fitted from outside the plastic tank and screwed and clipped to the counter-piece 3.

The terms “coupled,” “attached,” “fastened,” or “connected” may be used herein to refer to any type of relationship, direct or indirect, between the components in question, and may apply to electrical, mechanical, fluid, optical, electromagnetic, electromechanical or other connections. In addition, the terms “first,” “second,” etc. are used herein only to facilitate discussion, and carry no particular temporal or chronological significance unless otherwise indicated.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

### LIST OF REFERENCE SIGNS

1 Connection nipple
2 Tank wall
3 Counter-piece
4 Sealing face
5 Seal
6 Supporting sleeve
7 Screw thread
8 Rib
9 Connection piece

What is claimed is:

1. A plastic tank, comprising:
a tank body having a tank wall with an opening;
a connection device that includes a connection nipple that consists of a low-emission material, the connection nipple having a sealing face that faces an outer surface of the tank wall, the connection nipple being attached to the opening from outside of the tank wall;
a counter-piece arranged abut flatly against an inner surface of the tank wall around the opening, wherein the connection nipple is to the counter-piece via a screw connection; and
a seal arranged around the opening between the outer surface of the tank wall and the sealing face.

2. The plastic tank of claim 1, wherein the low-emission material consists of polyoxymethylene (POM).

3. The plastic tank of claim 1, wherein the counter-piece consists of polyoxymethylene.

4. The plastic tank of claim 1, wherein the counter-piece consists of high density polyethylene (HDPE).

5. The plastic tank of claim 1, wherein the counter-piece is sheathed with high density polyethylene (HDPE).

6. The plastic tank of claim 1, wherein the connection nipple is configured to connect a line.

7. The plastic tank of claim 1, wherein the connection nipple comprises a temperature sensor.

8. The plastic tank of claim 1, wherein the counter-piece is connected to the inner surface of the tank wall via a weld connection so as to lay flat against the tank wall around the opening.

9. A plastic tank, comprising:
a tank body having a tank wall with an opening;
a connection device that includes a connection nipple that consists of a low-emission material, the connection nipple having a sealing face that faces an outer surface of the tank wall, the connection nipple being inserted into the opening from outside of the tank wall;
a counter-piece arranged abut flatly against an inner surface of the tank wall around the opening, wherein the connection nipple is to the counter-piece via a screw connection; and
a seal arranged around the opening between the outer surface of the tank wall and the sealing face.

10. The plastic tank of claim 9, wherein the low-emission material consists of polyoxymethylene (POM).

11. The plastic tank of claim 9, wherein the counter-piece consists of polyoxymethylene.

12. The plastic tank of claim 9, wherein the counter-piece consists of high density polyethylene (HDPE).

13. The plastic tank of claim 9, wherein the counter-piece is sheathed with high density polyethylene (HDPE).

14. The plastic tank of claim 9, wherein the connection nipple is configured to connect a line.

15. The plastic tank of claim 9, wherein the connection nipple comprises a temperature sensor.

16. The plastic tank of claim 9, further comprising a supporting sleeve arranged on the inside of the counter-piece.

17. The plastic tank of claim 1, wherein the counter-piece is hooked in at the inside of the tank wall.

18. A method for manufacturing a plastic tank having a connection device, the method comprising:
thermoforming a plastic material to form the plastic tank while simultaneously welding a counter-piece to an inner surface of a tank wall;
arranging, after the thermoforming, a connection nipple from outside the plastic tank and then connecting the connection nipple to the counter-piece.

19. The method of claim 18, further comprising, after the thermoforming and before the arranging, forming opening in the tank wall, wherein the arranging comprises arranging the counter-piece through the opening from outside the plastic tank.

20. The method of claim 18, further comprising, after the thermoforming and before the arranging, applying a seal to the tank wall at a position of the counter-piece.
